(19) United States
(12) Patent Application Publication
(10) Pub. No.: US 2007/0286395 A1
(43) Pub. Date: Dec. 13, 2007

(54) Intelligent Multimedia Dial Tone

(75) Inventors: Baiju D. Mandalia, Boca Raton, FL (US); Pradeep P. Mansey, Coral Springs, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/420,161

(22) Filed: May 24, 2006

(51) Int. Cl. H04M 1/00; H04M 3/00

(52) U.S. Cl. 379/350

(57) ABSTRACT

A method for signaling a status of a communication device. One embodiment of the present invention can include receiving at least one user input on the communication device to initiate a call and, responsive to the user input, identifying at least one device parameter. At least one multimedia dial tone can be presented on the communication device. The multimedia dial tone can be selected from a plurality of multimedia dial tones and can correspond to the identified device parameter.

### BACKGROUND

1. Field of the Invention

The present invention relates to telecommunications and, more particularly, to telecommunication dial tones.

2. Description of the Related Art

A conventional land-based telephone emits a constant dial tone when the telephone is connected to a telephone exchange and the telephone exchange is ready to accept a call. The dial tone typically begins when the telephone enters a mode in which it is ready to place a call and stops when the first number is dialed. If the number dialed is busy, a busy tone usually is provided. A typical busy tone is a tone that is pulsed on and off at a predetermined rate. If a number is not dialed within a pre-determined amount of time, a rapidly pulsating tone is usually generated at an increased volume, thereby signaling that the telephone has been in an off-hook condition without call activity for too long of a period. Notwithstanding, the amount of information conveyed by these tones is rather limited.

Unlike a conventional land-based telephone, a mobile telephone generally does not emit a dial tone. Instead, a visual indicator is sometimes provided that indicates whether the mobile telephone is communicatively linked to a cellular communications network and to indicate a level of signal that is received from the communications network. In general, the indicator provides no other information about the status of the communications link between the mobile telephone and the communications network.

It would therefore be beneficial to provide a telephone status indicator that can relay a variety of status messages in a manner that is convenient to the telephone user.

### SUMMARY OF THE INVENTION

The present invention provides a method for signaling a status of a communication device. One embodiment of the present invention can include receiving at least one user input on the communication device to initiate a call and, responsive to the user input, identifying at least one device parameter. At least one multimedia dial tone can be presented on the communication device. The multimedia dial tone can be selected from a plurality of multimedia dial tones and can correspond to the identified device parameter.

Another embodiment of the present invention can include receiving at least one user input on the communication device to initiate a call and, responsive to the user input, identifying a first device parameter corresponding to a user preference. At least one multimedia dial tone can be presented on the communication device. The multimedia dial tone can be selected from a plurality of multimedia dial tones and can correspond to the first identified device parameter.

Yet another embodiment of the present invention can include a machine readable storage being programmed to cause a machine to perform the various steps and/or functions described herein.

### BRIEF DESCRIPTION OF THE DRAWINGS

There are shown in the drawings, embodiments which are presently preferred, it being understood; however, that the invention is not limited to the precise arrangements and instrumentalities shown.

FIG. 1 depicts a communications system in which multimedia dial tones are presented in accordance with an embodiment of the present invention.

FIG. 2 is a block diagram of a communication device that provides multimedia dial tones in accordance with another embodiment of the present invention.

FIG. 3 is a flow diagram illustrating a method of providing multimedia dial tones in accordance with another embodiment of the present invention.

FIG. 4 is a flow diagram illustrating a method of providing multimedia dial tones in accordance with yet another embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

The present invention relates to a method of signaling a status of a communication device by presenting to a user of the communication device any of a myriad of multimedia dial tones. The multimedia dial tones can be presented in response to a user input on the communication device to initiate a call. The multimedia dial tones can indicate, for example, currently available communication modes, call regions that are available to the communication device for placing a call, and call regions that are unavailable to the communication device. The multimedia dial tones also can prompt a user to enter additional user inputs, for example to select a contact to whom to place a call. Still, countless other multimedia dial tones can be provided and the invention is not limited in this regard. Moreover, in addition to being implemented in the context of telephone calls, the present invention also can be implemented with other types of communications, for instance other types of voice communications, chat sessions, short message service (SMS) messages, or any other communications that can be initiated by a user and that require realtime connection and interaction with a communications network.

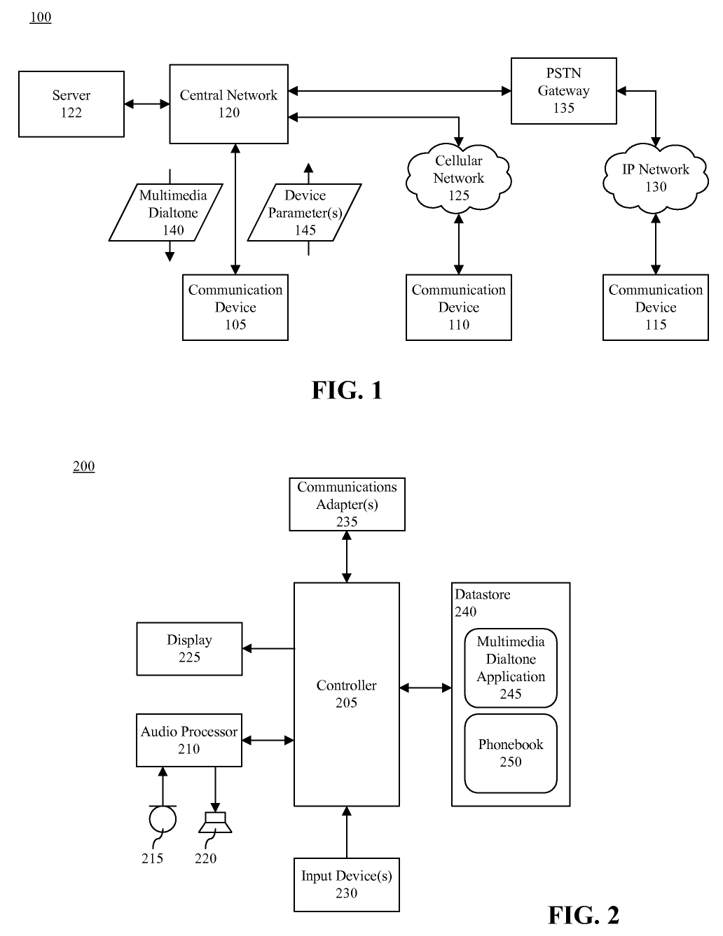

FIG. 1 depicts a communications system 100 in which multimedia dial tones are presented in accordance with an embodiment of the present invention. The communications system can include one or more communication devices 105, 110, 115 communicatively linked to a server 122 via a central network 120, for example a telephone exchange of a public switched telephone network (PSTN). The communication device 105 can be linked to the central network 120 via traditional land based telephone circuits, the communication device 110 can be linked to the central network 120 via a cellular communications network 125, and the communication device 115 can be linked to the central network 120 via the Internet 130 (e.g. using voice over IP communications). For instance, the communication device 115 can be an IEEE 802.11 WiFi telephone or a session initiation protocol (SIP) based IP telephone. A PSTN gateway 135 can be provided to bridge communications between the central network 120 and the Internet 130. In one arrangement, one or more of the communication devices 105-115 can link to the central network 120 via two or more communications networks. For example, the communication device 105 can link to the central network 120 via land based telephone circuits, the cellular communications network 125, and the Internet. Still, the system 100 can include other communication devices and other types of communications networks, and the invention is not limited in this regard.

When at least one communication channel is available between a communication device, such as the communication device 105, and the server 122 and a call session is initiated, a multimedia dial tone (hereinafter “dial tone”) 140 can be presented to a user of the communication device 105. The dial tone 140 can be generated by the server 120, generated by a component in the cellular communications network 125, for instance a basestation or basestation controller, generated by the PSTN gateway 135, generated by the communication device 105, or generated by any other suitable devices with which the communication device 105 is communicatively linked. The communication device 105 then can present the dial tone 140 to the user. In one arrangement, the dial tone 140 that is presented to the user can be selected by the server 122 based on one or more parameters 145 of the communication device 105. The parameters can include a status of the communication device, a user preference or any other defined parameter.

FIG. 2 is a block diagram of a communication device 200 that presents dial tones in accordance with an embodiment of the present invention. The communication device 200 can be, for example, a telephone, a mobile station, a personal digital assistant, a two-way radio, a computer, or any other communication device which can be used to support audio and/or video communications. The communication device can include a controller 205. The controller can comprise a central processing unit (CPU), a digital signal processor (DSP), an application specific integrated circuit (ASIC), a programmable logic device (PLD), a plurality of discrete components that cooperate to process data, and/or any other suitable processing device(s).

The communication device 200 also can include an audio processor 210 communicatively linked to the controller 205. The audio processor can receive input audio signals from an input audio transducer 215 and forward output audio signals to an output audio transducer 220. The audio processor 210 can comprise a CPU, a DSP, an ASIC, a PLD, discrete components, and/or any other device(s) suitable for processing audio data. In one arrangement, the audio processor 210 can be integrated into the controller 205.

The communication device 200 also can include a user interface communicatively linked to the controller 205. The user interface can include, for example, a display 225 and one or more input devices 230. One input device 230 can be, for instance, a keypad. Examples of other input devices 230 that can be provided include a stylus, an optical sensor, such as a camera, and a biometric device, such as a fingerprint reader. In one arrangement, the input device 230 can be a touch screen integrated with the display 225. Still, the communication device 200 can include any other suitable input devices and the invention is not limited in this regard.

One or more communications adapters 235 also can be communicatively linked to the controller 205. The communications adapters 235 can include, for example, a transceiver, a network adapter, a communications port, or any other component(s) suitable for communicating audio and/or visual data between the communication device 200 and one or more other devices to which the communication device 200 is communicatively linked.

The communication device 200 also can be communicatively linked to a datastore 240 such that the datastore 240 is accessible to the controller 205 and/or the audio processor 210. For example, the datastore 240 can be a component of the communication device 200, or accessible to the communication device 200 over a communications network. For instance, the datastore 240 can be located on a server with which the communication device 200 is communicatively linked. In such an arrangement, the communication device 200 can include another datastore (not shown) for storing local data.

A dial tone application 245 can be provided, at least a portion of which is stored in the datastore 240. Although the dial tone application 245 can be entirely stored on the datastore 240, the dial tone application 245 also can be stored across multiple datastores. Thus, certain functions of the dial tone application 245 may be executed locally on the communication device 200 while other functions are executed remotely, for example on a server.

The dial tone application 245 can be accessed by the controller 205 and/or the audio processor 210 when a user initiates a call session, for example by selecting a key, depressing a button, touching a portion of a touch screen, opening a cover of the communication device 200, taking a telephone handset off-hook, uttering a command and/or entering any other user input into the communication device 200 suitable for initiating a call session. The dial tone application 245 can present a dial tone on the communication device 200 that identifies at least one parameter representing a status of the communication device. The dial tone can include audio information and/or visual information. Accordingly, the dial tone can be presented via the output audio transducer 220 and/or the display 230. The dial tone can indicate the status of the communication device 200. For example, the dial tone can indicate whether one or more suitable communications networks are currently available to establish a call session.

The dial tone application 245 can be interactive and multi-staged. For instance, in response to the user initiating a call session, the dial tone can prompt the user to select from a plurality of available call modes, for instance by uttering a selection, or entering the selection on the input device 230. In an arrangement in which the communication device 200 can receive spoken utterances as commands, the dial tone application 245 can include, or interact with, a speech recognition application.

One example of a call mode can include a mode in which the communication device 200 communicates over a particular type of communications network. For instance, if the communication device 200 is configured to communicate over a plurality of different communications networks, for example a PSTN, a cellular communications network, an IEEE 802.11 communications network, and an IEEE 802.16 communications network, the dial tone can be used to present a list of such communications networks that are currently available. The indication can be presented visually as a menu of selectable items shown on the display 225 or as an audio signal generated by the output audio transducer 220. The audio signal can be presented as a tone, a series of tones, speech, or any other suitable audio signal that prompts the user to enter a user selection. In an arrangement in which the audio signal is presented as speech, the dial tone application 245 can include, or interact with, a text-to-speech application. Alternatively, pre-recorded spoken utterances can be presented.

In another example, in response to the user initiating a call session, the multimedia dial tone can prompt the user to select a contact or telephone number to dial. A contact can be a person, an organization, a business, a particular communication device, or any other entity to which a call can be placed. For instance, in response to the dial tone prompt, the user can utter a person's name. The dial tone application 245 then can access a digital phonebook 250 to retrieve a telephone number that matches the uttered name, and place a call to the retrieved telephone number. Moreover, the dial tone can perform other automated call attendant functions. For example, the dial tone can redial a number that previously was busy or unreachable. Further, based on device capabilities, the dial tone application can present the user with options for placing a voice call, sending a SMS message, sending an e-mail message, and the like.

The dial tone application 245 also can be used to implement security functions on the communication device 200. For example, when the communication device 200 is activated, or before allowing a call to be placed on the communication device 200, a dial tone can be presented to prompt the user to enter a personal identification number or provide a biometric entry. The biometric entry can be a finger print, a voice print or an image that can be detected optically, for instance an eye scan or a facial scan. If an appropriate user entry is not received, the dial tone application 245 can limit the functionality of the communication device 200 that is available to the user.

The dial tone also can indicate to the user features of the communication device 200 that are available to the user based on the user's assigned security settings. For example, if a particular user is only authorized to call specific regions, such regions can be presented to the user on the display 225 and/or presented as an audio signal generated by the output audio transducer 220. For instance, the user can be presented with names, zipcodes, area codes, country codes, or any other suitable identifiers that indicate where the user is authorized to place calls. In one arrangement, the dial tone also can indicate an amount of communication time available to the user on the communication device 200.

If the user attempts to place a call to an unauthorized region, the dial tone application 245 can prevent such call from being placed. Further, the dial tone application 245 can generate a dial tone that indicates to the user that the call cannot be placed. Optionally, the dial tone can provide a reason for the call not being placed. For example, the dial tone can indicate that the attempted call was directed to an unauthorized call region.

If the user has initiated a call session, but fails to place the call within a defined period, a dial tone can be presented that prompts the user to complete the steps required to establish the call or to end the call session initiation sequence. The dial tone that is presented can be intelligently selected to help guide the user through the call initiation process. For example, if the next step in the call initiation process is to select the communications network over which to place the call, and the user has not selected such a network within thirty seconds of the original prompt, the dial tone can re-prompt the user to select a communications network. The dial tone also can indicate to the user that a help menu is available and prompt the user to enter a particular input if access to the help menu is desired. Of course, dial tones can be presented to prompt the user to enter any of a myriad of suitable user inputs and the invention is not limited in this regard.

The dial tone application 245 can include a plurality of customizable user settings which enable a user to specify the dial tones with which he is presented. For example, the user can configure the dial tone application 245 to prompt the user to select a contact to whom to place a call each time a call session is initiated. Alternatively, the user can configure the dial tone application 245 to prompt the user to select a particular communications network over which to communicate each time a call session is initiated. In yet another arrangement, the user can enter one or more customized dial tones to be presented when a call session is initiated.

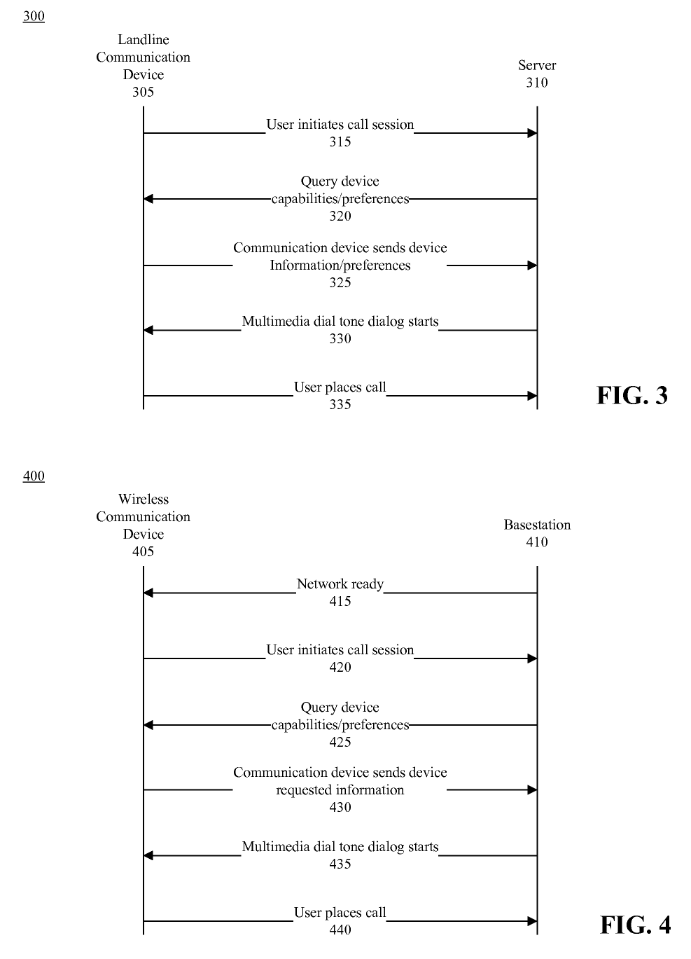

FIG. 3 is a flow diagram illustrating a method 300 of providing dial tones in accordance with another embodiment of the present invention. In particular, the method 300 represents message exchanges which can occur between a landline communication device 305 and a server 310. The server can be, for instance, a telephone exchange of a PSTN or a central office. Beginning at step 315 a user can initiate a call session, for example by taking a telephone receiver off-hook. At step 320, the server 310 can query the communication device 305 to identify device status and/or user preferences. The device status can include, for instance, the device capabilities. At step 325 the communication device 305 can send the requested information. Proceeding to step 330, the server 310 can initiate a dial tone dialog. For instance, the server 310 can process the information received from the communication device 305 to select an appropriate dial tone for presentation to the user. The selected dial tone then can be forwarded to the communication device 305 and presented to the user. At step 335 the server 310 can receive a call placed by the user on the communication device 305.

FIG. 4 is a flow diagram illustrating a method 400 of providing dial tones in accordance with yet another embodiment of the present invention. In particular, the method 400 represents message exchanges which can occur between a wireless communication device 405 and a basestation 410 of a cellular communications system. Beginning at step 415, the wireless communication device 405 can establish its presence in a region serviced by the basestation 410 and verify that the cellular communications system is ready to receive a call from the communication device 405. At step 420 a user can initiate a call session, for example by pushing a place call key. At step 425, the communication device 405 can be queried to identify the device status and/or user preferences. The query can originate from a server, such as a basestation controller, a central office, a telephone exchange or any other device or system suitable for communicating dial tones to the wireless communication device 405 via the basestation 410. At step 430 the communication device 405 can send the requested information to the basestation, which can forward the information to the server. Proceeding to step 435, a dial tone dialog can be initiated. For instance, the server can process the information received from the communication device 405 to select an appropriate dial tone for presentation to the user. The selected dial tone then can be forwarded to the basestation, transmitted to the communication device 405 and presented to the user. At step 440 the basestation 410 can receive a call placed by the user on the communication device 405.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The term “dial tone”, as used herein, is an indication provided on a communication device that signifies at least one communication channel is available to the communication device for a call to be placed. In the present context, a dial tone can include audio and/or visual information. The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, a computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an”, as used herein, are defined as one or more than one. The term “plurality”, as used herein, is defined as two or more than two. The term “another”, as used herein, is defined as at least a second or more. The terms “including” and/or “having”, as used herein, are defined as comprising, i.e. open language. The term “coupled”, as used herein, is defined as connected, although not necessarily directly, and not necessarily mechanically, e.g. communicatively linked through a communication channel or pathway or another component or system.

This invention can be embodied in other forms without departing from the spirit or essential attributes thereof. Accordingly, reference should be made to the following claims, rather than to the foregoing specification, as indicating the scope of the invention.

What is claimed is:

1. A method for signaling a status of a communication device comprising:
receiving at least one user input on the communication device to initiate a call;
responsive to the user input, identifying at least one device parameter; and
presenting at least one multimedia dial tone on the communication device, the multimedia dial tone selected from a plurality of multimedia dial tones and corresponding to the identified device parameter.

2. The method of claim 1, wherein identifying the device parameter comprises identifying at least one parameter selected from the group consisting of a status of the communication device and a user preference.

3. The method of claim 1, further comprising:
communicating the communication device parameter to a server; and
receiving the multimedia dial tone from the server.

4. The method of claim 1, wherein receiving the user input comprises receiving a biometric user input.

5. The method of claim 1, further comprising:
responsive to the user input, selecting a call mode from a plurality of available call modes; and
placing a call from the communication device in accordance with the selected call mode.

6. The method of claim 1, further comprising:
responsive to receiving a place call request to a call region where the user is not authorized to call, presenting a second multimedia dial tone on the communication device, the second multimedia dial tone indicating that a call cannot be placed in accordance with the call request.

7. The method of claim 1, wherein presenting the multimedia dial tone comprises presenting both visual information and audio information.

8. The method of claim 1, wherein presenting the multimedia dial tone comprises prompting the user to enter a second user input.

9. A method for signaling a status of a communication device comprising:
receiving at least one user input on the communication device to initiate a call;
responsive to the user input, identifying a first device parameter corresponding to a user preference; and
presenting at least one multimedia dial tone on the communication device both as visual information and audio information, the multimedia dial tone selected from a plurality of multimedia dial tones and corresponding to the first identified device parameter.

10. The method of claim 9, further comprising identifying at least a second device parameter corresponding to a status of the communication device, wherein the selected multimedia dial tone also corresponds to the second device parameter.

11. The method of claim 9, further comprising:
communicating the first and second communication device parameters to a server; and
receiving the multimedia dial tone from the server.

12. The method of claim 9, further comprising:
responsive to the user input, selecting a call mode from a plurality of available call modes; and
placing a call from the communication device in accordance with the selected call mode.

13. The method of claim 9, further comprising:
responsive to receiving a place call request to a call region where the user is not authorized to call, presenting a second multimedia dial tone on the communication device, the second multimedia dial tone indicating that a call cannot be placed in accordance with the call request.

14. A machine readable storage, having stored thereon a computer program having a plurality of code sections comprising:
code for receiving at least one user input on the communication device to initiate a call;
code for identifying at least one device parameter in response to the user input; and
code for presenting at least one multimedia dial tone on the communication device, the multimedia dial tone selected from a plurality of multimedia dial tones and corresponding to the identified device parameter.

15. The machine readable storage of claim 14, wherein the code for identifying the device parameter comprises code for identifying at least one parameter selected from the group consisting of a status of the communication device and a user preference.

16. The machine readable storage of claim 14, further comprising:
code for communicating the communication device parameter to a server; and
code for receiving the multimedia dial tone from the server.

17. The machine readable storage of claim 14, further comprising:
code for selecting a call mode from a plurality of available call modes in response to the user input; and
code for placing a call from the communication device in accordance with the selected call mode.

18. The machine readable storage of claim 14, further comprising:
code for presenting a second multimedia dial tone on the communication device in response to receiving a place call request to a call region where the user is not authorized to call, the second multimedia dial tone indicating that a call cannot be placed in accordance with the call request.

19. The machine readable storage of claim 14, wherein the code for presenting the multimedia dial tone comprises code for presenting both visual information and audio information.

20. The machine readable storage of claim 14, wherein the code for presenting the multimedia dial tone comprises code for prompting a user to enter a second user input.
